(19) United States
(12) Patent Application Publication
(10) Pub. No.: US 2025/0291362 A1
(43) Pub. Date: Sep. 18, 2025

(54) SYSTEM AND METHOD FOR PERFORMING INTERACTIONS WITH PHYSICAL OBJECTS BASED ON FUSION OF MULTIPLE SENSORS

(71) Applicant: Seegrid Corporation, Pittsburgh, PA (US)

(72) Inventors: Nicholas Alan Melchior, Pittsburgh, PA (US); Andrew Dempsey Tracy, Pittsburgh, PA (US); Benjamin George Schmidt, Wexford, PA (US); Ryan Young, Newtown, PA (US); Sean Kelly, Media, PA (US)

(21) Appl. No.: 18/862,699

(22) PCT Filed: May 26, 2023
(86) PCT No.: PCT/US2023/023699

§ 371 Date: Nov. 4, 2024

Related U.S. Application Data
(60) Provisional application No. 63/346,483, filed on May 27, 2022.

(51) Int. Cl. G05D 1/667; B66F 9/06; B66F 9/075; G01S 17/89; G05D 1/246; G05D 105/28; G05D 107/70; G05D 111/10

(52) U.S. Cl. CPC G05D 1/667; B66F 9/063; B66F 9/0755; G01S 17/89; G05D 1/246; G05D 2105/28; G05D 2107/70; G05D 2111/17

(57) ABSTRACT

An autonomous mobile robot (AMR) is provided, comprising a chassis, a navigation system, and a load engagement portion, a plurality of sensors, including an object detection sensor, a load identification sensor, and a load presence sensor, and a load interaction system. The load detection system is configured to exchange information with the plurality of sensors and configured to operate in a load engagement mode and a load drop mode by selectively fusing data from among the plurality of sensors in each mode.

### CROSS REFERENCE TO RELATED APPLICATIONS

This application claims the benefit of priority from U.S. Provisional Patent Appl. 63/346,483, filed on May 27, 2022, entitled System and Method for Performing Interactions with Physical Objects Based on Fusion of Multiple Sensors, the contents of which are incorporated herein by reference.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle-Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement/Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure, the contents of which are incorporated herein by reference.

The present application may be related to U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Frameworkfor Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520 filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to U.S. Provisional Appl. 63/324,182 filed on Mar. 28, 2022, entitled A Hybrid, Context-aware Localization System for Ground Vehicles; U.S. Provisional Appl. 63/324,184 filed on Mar. 28, 2022, entitled Safety Field Switching Based On End Effector Conditions; U.S. Provisional Appl. 63/324,185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. Provisional Appl. 63/324,190 filed on Mar. 28, 2022, entitled Passively Actuated Sensor Deployment; U.S. Provisional Appl. 63/324,192 filed on Mar. 28, 2022, entitled Automated Identification Of Potential Obstructions In A Targeted Drop Zone; U.S. Provisional Appl. 63/324,193 filed on Mar. 28, 2022, entitled Localization Of Horizontal Infrastructure Using Point Clouds; U.S. Provisional Appl. 63/324,195 filed on Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 63/324,199 filed on Mar. 28, 2022, entitled Validating The Pose Of An AMR That Allows It To Interact With An Object; and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; US Design Patent Appl. 29/398,127, filed on Jul. 26, 2011, U.S. Pat. No. D680,142, Issued on Apr. 16, 2013, entitled Multi-Camera Head; US Design Patent Appl. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to systems and methods in the field of autonomous and/or robotic vehicles. Aspects of the inventive concepts are applicable to any mobile robotics application involving interactions with physical objects.

### BACKGROUND

Autonomous mobile robots (AMRs) are taught discrete, well-defined locations within a facility where they can pick or drop loads, e.g., a pallet of goods. If there are multiple locations in a region where it is desirable for an AMR to pick up or drop off a load, the region must be broken up into small discrete areas that are individually addressed, as pick or drop locations. Using onboard sensors, the AMR can navigate to a predetermined, individually addressed pick or drop location and attempt a planned pick or drop. Once at a pick location, the AMR can use one or more of these sensors to identify a load in the well-defined pick area and engage the load for transportation. The AMR may use sensor data to adjust its trajectory to the load for proper load engagement. Once at a drop location, the AMR can use one or more of the sensors to determine if the well-defined, individually addressed drop location is free and clear for the drop therein. The AMR does not utilize sensor data to look beyond the well-defined pick or drop location for picking or dropping loads.

The challenge faced with conventional AMRs, therefore, is that each pick or drop action must be specified at a specific individually addressed location. Some AMRs leverage sensors to localize loads and adjust their trajectory to them, but that is still within a small local area.

It would be advantageous to have an AMR that can utilize senor data to drop or pick loads outside the relatively small and well-defined pick area. It would also be advantageous to have an AMR system and method that allows the definition of a region of arbitrary length that their AMRs can pick and/or drop in. These and other advantages of the inventive concepts described herein will be apparent to those skilled in the art.

### SUMMARY OF THE INVENTION

The inventive concepts relate to a system and method that allow an AMR to locate and interact with physical objects leveraging a combination of feedback from multiple sensors. Embodiments of the specific system for an AMR can leverage two planar scanners, a paddle sensor for pallet presence, and a camera executed by pallet detection system (PDS) software.

In accordance with one aspect of the inventive concepts, provided is an autonomous mobile robot (AMR), comprising: a chassis, a navigation system, and a load engagement portion; a plurality of sensors, including an object detection sensor, a load identification sensor, and a load presence sensor; a load interaction system configured to exchange information with the plurality of sensors, and configured to operate in a load engagement mode and a load drop mode by selectively fusing data from among the plurality of sensors in each mode.

In various embodiments, the object detection sensor includes at least one planar scanner or other type of depth sensor.

In various embodiments, the at least one planar scanner is at least one LiDAR scanner.

In various embodiments, the at least one LiDAR scanner includes at least one fork tip scanner.

In various embodiments, the load detection sensor includes a pallet detection scanner, sensor, or system.

In various embodiments, the pallet detection scanner, sensor, or system includes a 3D sensor and/or a 3D camera.

In various embodiments, the load presence sensor includes at least one a paddle sensor.

In various embodiments, the at least one engagement or at least one paddle sensor is arranged to trip when the load is fully engaged by the AMR.

In various embodiments, the load interaction system is configured to locate the load using a low-fidelity mode.

In various embodiments, the load interaction system is configured to switch to a high-fidelity mode to engage the load.

In various embodiments, the load interaction system is configured to use at least one of the plurality sensors to perform object detection when approaching a load drop off zone.

In various embodiments, the load interaction system is configured to locate the load using a low fidelity mode.

In various embodiments, the load interaction system is configured to locate an object of interest (OOI) as a reference for dropping the load.

In various embodiments, the load interaction system is configured to determine a load drop zone offset from the object of interest (OOI).

In accordance with another aspect of the inventive concept, provided is a load interaction method of an autonomous mobile robot (AMR), comprising: providing the AMR including a chassis, a navigation system, and a load engagement portion; a plurality of sensors, including an object detection sensor, a load identification sensor, and a load presence sensor; and a load interaction system. The load interaction system exchanges information with the plurality of sensors and can operate in either of a load engagement mode or a load drop mode by selectively fusing data from among the plurality of sensors in each mode.

In various embodiments, the object detection sensor includes at least one planar scanner or other type of depth sensor.

In various embodiments, the at least one planar scanner is at least one LiDAR scanner.

In various embodiments, the at least one LiDAR scanner includes at least one fork tip scanner.

In various embodiments, the load detection sensor includes a pallet detection scanner, sensor, or system.

In various embodiments, the pallet detection scanner, sensor, or system includes a 3D sensor and/or a 3D camera.

In various embodiments, load presence sensor includes at least one a paddle sensor.

In various embodiments, the at least one engagement or at least one paddle sensor is arranged to trip when the load is fully engaged by the AMR.

In various embodiments, the method further comprises the load interaction system locating the load using a low-fidelity mode.

In various embodiments, the method further comprises switching to a high-fidelity mode to engage the load.

In various embodiments, the method further comprises using at least one of the plurality sensors to perform object detection when approaching a load drop off zone.

In various embodiments, the method further comprises locating the load using a low fidelity mode.

In various embodiments, the method further comprises locating an object of interest (OOI) as a reference for dropping the load.

In various embodiments, the method further comprises determining a load drop zone offset from the object of interest (OOI).

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1A provides a perspective view of a robotic vehicle in accordance with aspects of the inventive concepts.

FIG. 1B provides a side view of a robotic vehicle with its load engagement portion retracted, in accordance with aspects of the inventive concepts.

FIG. 1C provides a side view of a robotic vehicle with its load engagement portion extended, in accordance with aspects of the inventive concepts.

FIG. 2 is a block diagram of an embodiment of an AMR, in accordance with aspects of the inventive concepts.

FIG. 3 is a method for engaging with a load by an AMR, in accordance with aspects of the inventive concepts.

FIG. 4 is a method for dropping a load by an AMR, in accordance with aspects of the inventive concepts.

FIG. 5 is a method for engaging with a load, in accordance with aspects of the inventive concepts.

FIG. 6A is a diagram of an embodiment of an AMR performing a load pickup operation, in accordance with aspects of the inventive concepts.

FIG. 6B is a diagram of an embodiment of an AMR having picked up the load of FIG. 6A, in accordance with aspects of the inventive concepts.

FIG. 7 is a method for dropping a load by an AMR, in accordance with aspects of the inventive concepts.

FIG. 8 is a diagram of an embodiment of an AMR performing a load drop off operation, in accordance with aspects of the inventive concepts.

### DESCRIPTION OF PREFERRED EMBODIMENTS

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

The inventive concepts relate to a system and method that allow an AMR to locate and interact with physical objects leveraging a combination of feedback from multiple sensors. In various embodiments, a system in accordance with aspects of the inventive concepts can take the form of an AMR with the following sensors: fork-tip embedded planar LiDAR sensors, a pallet localization sensor, and a load engagement sensor. In various embodiments, a specific embodiment of a system including an AMR can leverage two planar scanners, and/or other type of depth sensor, a paddle sensor as an engagement sensor for pallet presence detection, and at least one camera, for example, provided by ifm electronic gmbh, Germany, executing pallet detection system (PDS) software.

In various embodiments, the system leverages these sensors to dynamically adjust how the AMR behaves when attempting to pick (load) or drop (unload) pallets. During a pick, the AMR leverages the planar scanners to allow the AMR to get close to a pickable object, while also detecting obstacles in the AMR's path, then leverages the PDS to localize the pickable object relative to the AMR, finally the paddle presence sensor is used to signal that the AMR has successfully engaged with the load. During a drop, the planar scanners are used to locate a free area to drop the load, as well as identify obstacles as the AMR approaches the drop location. This method of sensing and switching the use of the sensors allows the AMRs to operate in arbitrarily long straight-line regions.

Prior approaches that did not use a collection of sensors to determine where interactions should occur relied on precisely trained locations for load interactions. This reliance meant AMRs were constrained to only interact with loads at specific locations that had to be manually specified individually. Additionally, they were reliant on precise positioning of those loads at those locations during operation for the interactions to succeed.

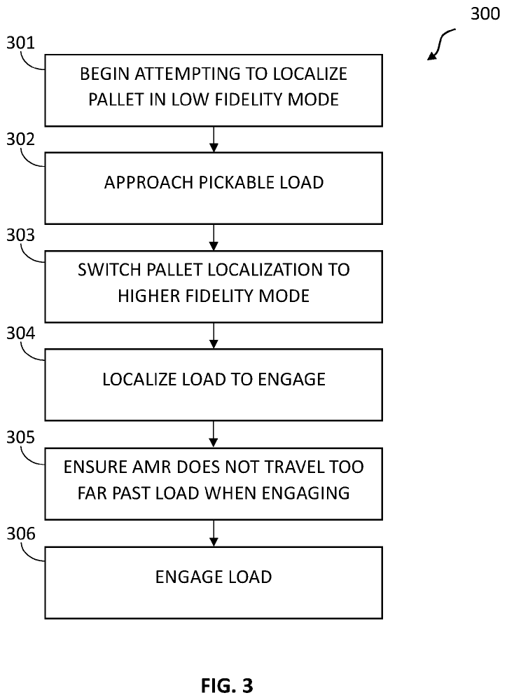

In various embodiments, a method is performed for engaging a load, carried out by a properly equipped and configured AMR, in accordance with aspects of the inventive concepts, for example, described with reference to FIGS. 3-6B. In other embodiments, a method is performed for dropping a load, carried out by a properly equipped AMR, in accordance with aspects of the inventive concepts, for example, described in FIGS. 3, 7, and 8. The methods described in the embodiments herein can be used for all AMRs that have sensors that satisfy the conditions described above and can benefit from picking and/or dropping a load in a straight-line continuous region. For pallet engagement specifically, examples of AMRs could be the Palion™ pallet jack AMRs as well as the Palion™ lift AMRs from Seegrid Corporation, Pittsburgh, Pennsylvania. (Palion™ is a trademark of Seegrid Corporation, Pittsburgh, PA.) One or more methods could also be extended to work with tuggers, where, for example, a tow bar localization sensor could be used in place of a pallet localization sensor.

Some methods in accordance with the inventive concepts enable AMR users to define regions within which AMRs can pick and drop loads without needing to specify discrete load locations. The methods specifically help with the operations inside of those regions. An AMR user is free to place loads with a large front-to-back tolerance anywhere within the region, meaning their employees or system are not required to be very precise.

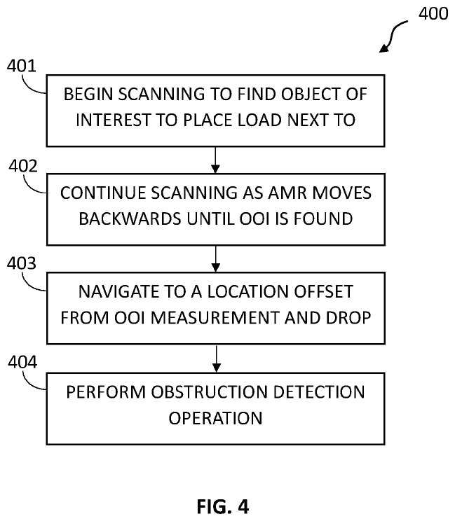

In various embodiments, as described below in FIGS. 3 and 4, the methods can be broken up into two parts: (1) a method for engaging with a load and (2) a method for dropping a load. The two methods have some things in common: they both use information from a collection of sensors to achieve their goal and they both change how the AMR interprets the data coming from the sensors based on what is happening during the execution of the action.

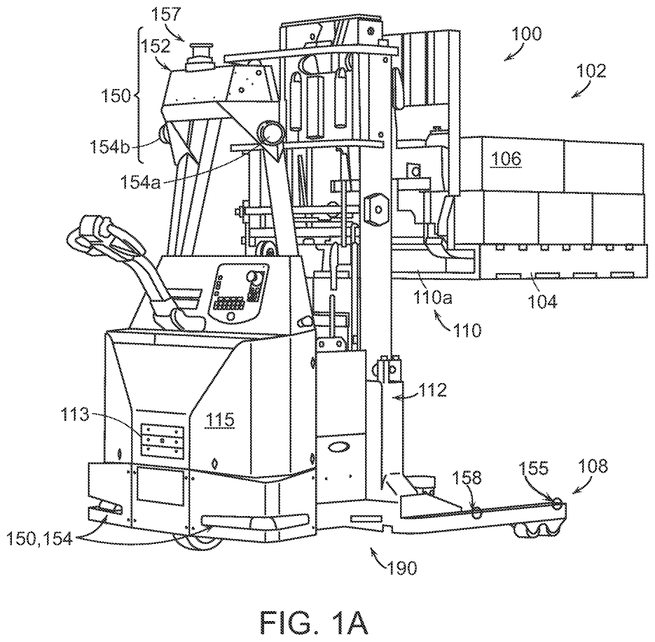

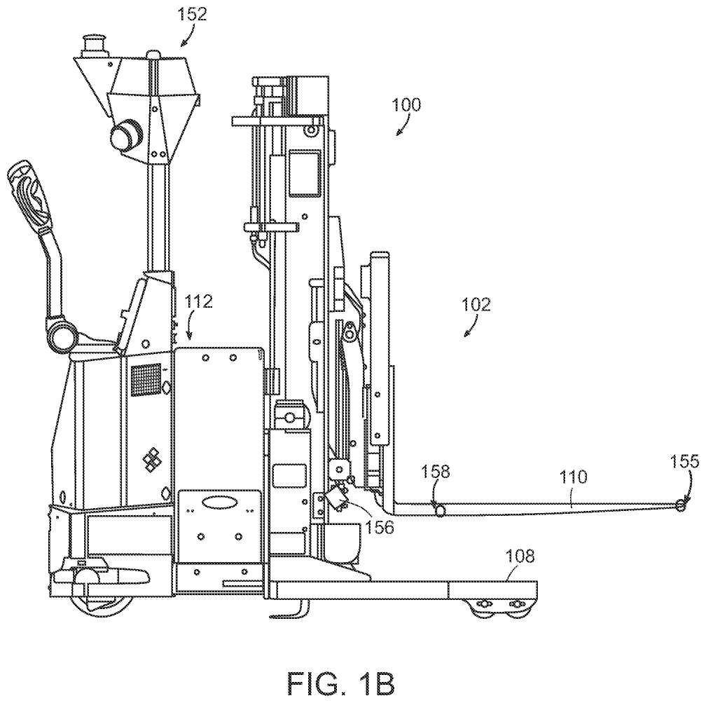

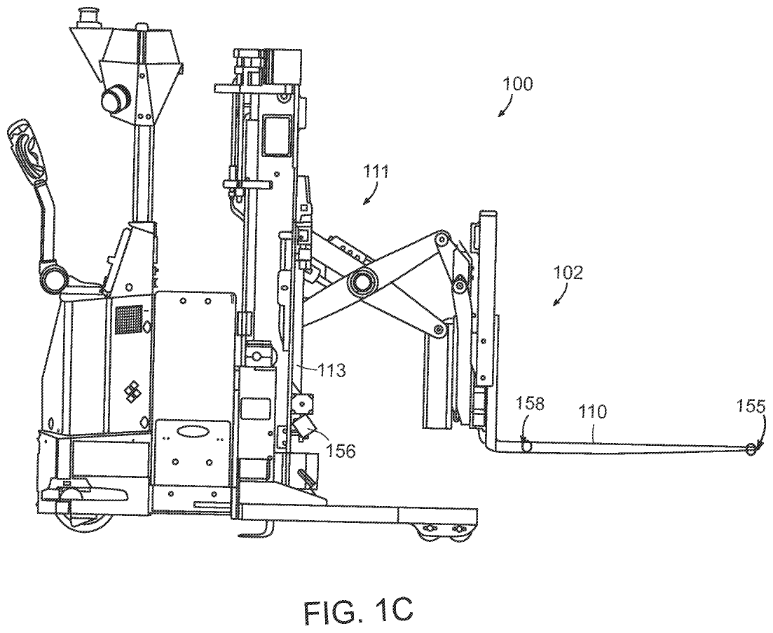

Referring to FIG. 1A through 1C, collectively referred to as FIG. 1, shown is an example of a self-driving or robotic vehicle 100 in the form of an AMR that can be configured with the sensing, processing, and memory devices and subsystems necessary and/or useful for performing self-calibration in accordance with aspects of the inventive concepts. The robotic vehicle 100 can take the form of an AMR lift truck, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a pallet 104 loaded with a load 106, for example, a number of goods for transporting between locations. To engage and carry the pallet 104, the robotic vehicle may include a pair of forks 110, and as shown in FIG. 4, includes first and second forks 110a,b. Outriggers 108 extend from the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a carriage 113 that enable the robotic vehicle 100 to raise and lower, side-shift, and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load. In various embodiments, the robotic vehicle may be configured to robotically control the yaw, pitch, and/or roll of the forks 110 to pick a palletized load in view of the pose of the horizontal surface that is to receive the load.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in a 3D model and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

The sensors 150 can include one or more stereo cameras 152 and/or other volumetric sensors, sonar sensors, radars, and/or LiDAR scanners or sensors 154, as examples. Inventive concepts are not limited to particular types of sensors. In various embodiments, sensor data from one or more of the sensors 150, e.g., one or more stereo cameras 152 and/or LiDAR scanners 154 can be used to generate and/or update a 2-dimensional or 3-dimensional model or map of the environment, and sensor data from one or more of the sensors 150 can be used for the determining location of the robotic vehicle 100 within the environment relative to the electronic map of the environment. In some embodiments, calibration techniques described herein are performed on one or more 3D LiDAR or carriage sensors 156.

Sensors 150 and 154 can include forward primary safety sensors. In the embodiment shown in FIG. 1A, there are two LiDAR devices 154a, 154b positioned at the top left and right of the robotic vehicle 100. In the embodiment shown in FIG. 1, at least one of the LiDAR devices 154a,b can be a 2D or 3D LiDAR device. In alternative embodiments, a different number of 2D or 3D LiDAR devices are positioned near the top of the robotic vehicle 100. Also, in this embodiment a LiDAR device 157 is located at the top of the mast. In some embodiments, the LiDAR device 157 is a 2D LiDAR used for navigation and localization.

In some embodiments, the sensors 150 can include sensors configured to detect objects in the payload area and/or behind the forks 110a,b. The sensors can be used in combination with others of the sensors, e.g., stereo camera head 152. In some embodiments, the sensors 150 can include one or more carriage sensors 156 oriented to collected 3D sensor data of the payload area 102 and/or forks 110. The carriage sensors 156 can include a 3D camera and/or a LiDAR scanner, as examples. In some embodiments, the carriage sensors 156 can be coupled to the robotic vehicle 100 so that they move in response to movement of the actuators 111 and/or fork 110. For example, in some embodiments, the carriage sensors 156 can be mounted to the mast and/or carriage 113 so that the sensor can move in response to up and down, side-shift left and right, and/or extension and retraction movement of the forks. In some embodiments, the carriage sensors 156 collect 3D sensor data as they move with the forks 110.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

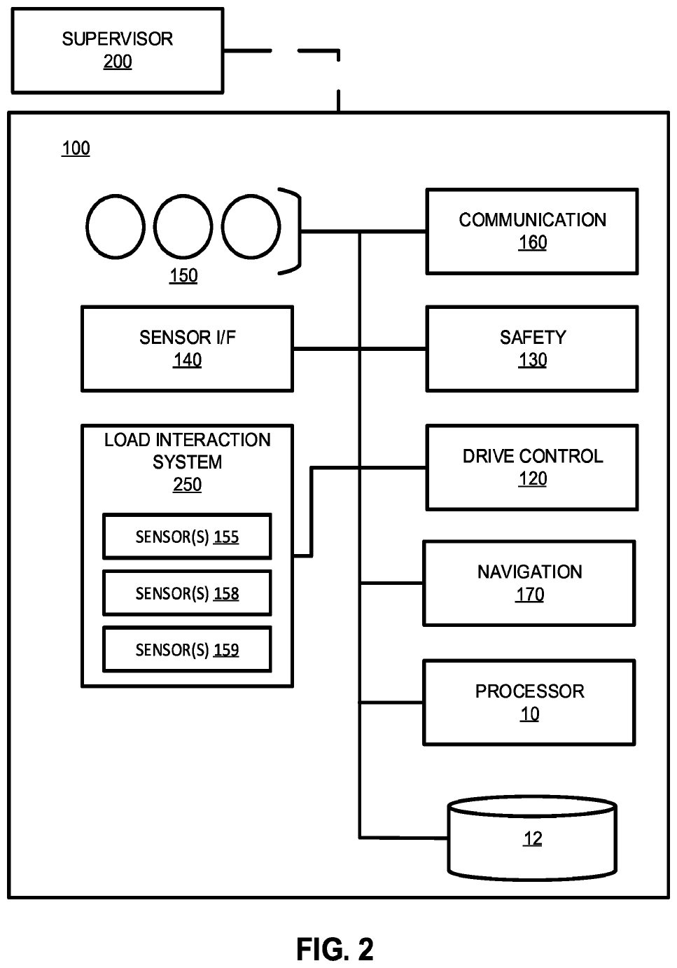

FIG. 2 is a block diagram of components of an embodiment of the robotic vehicle 100 of FIG. 1, incorporating technology for automated detection and localization of horizontal infrastructures, in accordance with principles of inventive concepts. The embodiment of FIG. 2 is an example; other embodiments of the robotic vehicle 100 can include other components and/or terminology. In the example embodiment shown in FIGS. 1A-2, the robotic vehicle 100 is a warehouse robotic vehicle, which can interface and exchange information with one or more external systems, including a supervisor system, fleet management system, and/or warehouse management system (collectively “supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers, and transmitters that enable communication with the supervisor 200 and any other external systems over any now known or hereafter developed communication technology, such as various types of wireless technology including, but not limited to, WiFi, Bluetooth™, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. The path may be stored for future use and may be updated, for example, to include more, less, or different locations, or to otherwise revise the path and/or path segments, as examples.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as the electronic map of the environment. In some embodiments, the memory 12 stores relevant measurement data for use by the extrinsic calibration module 180 in performing a calibration operation, for example, proprioceptive data such as encoder measurements, sensor measurement, and so on.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 170 configured to access environmental data, such as the electronic map, and path information stored in memory 12, as examples. The navigation module 170 can communicate instructions to a drive control subsystem 120 to cause the robotic vehicle 100 to navigate its path within the environment. During vehicle travel, the navigation module 170 may receive information from one or more sensors 150, via a sensor interface (I/F) 140, to control and adjust the navigation of the robotic vehicle. For example, the sensors 150 may provide 2D and/or 3D sensor data to the navigation module 170 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles. The robotic vehicle may also include a human user interface configured to receive human operator inputs, e.g., a pick or drop complete input at a stop on the path. Other human inputs could also be accommodated, such as inputting map, path, and/or configuration information.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

In some embodiments, the robotic vehicle includes a load interaction system 250 that manages drop off and pick up loads, for example, the palletized load 106 shown in FIG. 1A. Here, the robotic vehicle 100 is an AMR forklift for transporting the load 106 that has been picked up and can be dropped off, both operations in accordance with the inventive concepts. In doing so, the AMR forklift 100 can be equipped with a combination of sensors described herein, which may be part of the load interaction system 250, or in electronic communication with one or more processors of the load interaction system 250.

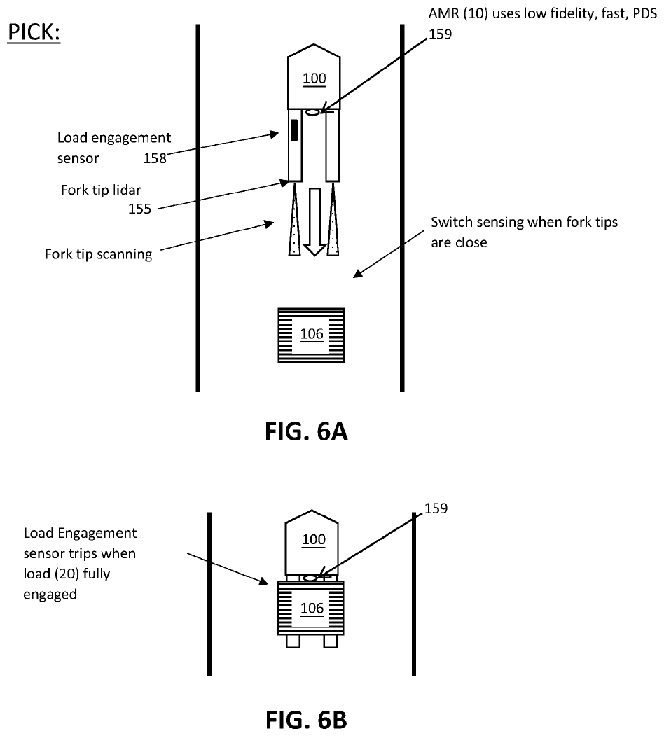

The specific system for a robotic vehicle 100 such as an AMR can leverage two planar scanners (or other types of depth sensors), for example, fork-tip embedded planar LiDAR sensors 155, a paddle sensor 158 also on at least one fork but for pallet presence and an IFM camera 159, e.g., developed by ifm electronic gmbh, Germany running their pallet detection system (PDS) software. For example, as shown in FIG. 6A, the pallet localization sensor 159 can be located at the bottom of the backrest between the forks. In some embodiments (not shown), a paddle sensor 158 can be on the backrest of the AMR. The load interaction system 250 may include the sensors 155, 158, 159 for performing operations according to one or more methods herein. One or more sensors 155, 158, 159 may be other examples of the sensors 150 of the robotic vehicle 100. For example, the load interaction system 250 may receive information from one or more sensors 155, 158, 159 via the sensor interface (I/F) 140 to interact with physical objects.

FIG. 3 is a method 300 for engaging a load by a robotic vehicle 100, e.g., AMR, in accordance with aspects of the inventive concepts. In describing the method 300, reference is made to the AMR 100 of FIGS. 1A-2.

The method 300 begins at step 301 by attempting to localize a load 106, e.g., a pallet carrying goods, in a low fidelity mode. A low fidelity mode can be performed by a PDS algorithm, for example, with respect to the sensor 159 for the purpose of operating in a less-than-ideal environment where the AMR searches for a pallet while moving but does not need to stop to detect the pallet.

At step 302, the AMR 100 approaches a pickable load until the planar scanners 155 indicates that the AMR is at an ideal pallet localization range.

At step 303, the load interaction system 250 switches the pallet localization to a higher fidelity mode.

At step 304, when in the higher fidelity mode, the load interaction system 250 localizes the load 106 to engage with the AMR 100. Here, a slower version of the PDS algorithm is executed. In the event that the AMR cannot find the pallet while moving, if the AMR stops, then sufficient time can be provided to detect a pallet of interest.

At step 305, the load interaction system 250 leverages that localization to ensure the AMR 100 does not travel too far past the load 106 when engaging. Here, the pallet localization system can identify if the face of the pallet is relative to the AMR 100. It is assumed that the pallet is stationary while the AMR 100 moves through the space. A spot can be established (e.g., marked) just past the face of the pallet that if the AMR reaches it without sensing that an assumption can be made that the AMR 100 is engaged with the pallet, and the AMR 100 can be stopped to prevent it from traveling too far. The pallet localization algorithm gives a location for where the face of the pallet is in 3D space relative to the AMR 100. A computer processor executing the pallet localization algorithm can translate that location into a path coordinate system and mark a location at that spot with an offset to stop the AMR 100 from continuing backwards if we have not fully engaged with the load, as indicated by the payload presence sensor.

At step 306, the engagement operation proceeds until the engagement sensor 158 indicates a load 106 is engaged.

FIG. 4 is a method 400 for dropping a load 106 by an AMR 100, in accordance with aspects of the inventive concepts.

At step 401, the AMR 100 initiates a scanning operation using the planar scanners 155 to find an object of interest (OOI) to place the load 106 next to.

At step 402, the scanning operation continues as the AMR moves backwards until an OOI is located.

At step 403, if the OOI is located, the load interaction system 250 can perform an operation to navigate the AMR 100 to a location offset from the measurement of the OOI for dropping the load.

At step 404, after the OOI is found, the planar scanners 155 perform an obstruction detection operation for safety. A safety operation can be performed by changing the manner in which the system interprets the data coming from the scanner from looking for an OOI to checking for obstacles. This is be achieved by two different pipelines for interpreting data from the sensor and at runtime, based on where the AMR 100 is, and selecting which pipeline to process the sensor scans through.

As described above, conventional AMRs are constrained to only interacting with loads at specific locations that had to be manually specified individually. Additionally, they are reliant on precise positioning of those loads at those locations during operation for the interactions to succeed. In contrast, the AMR 100 according to embodiments of the present inventive concept includes a load interaction system 250 comprising sensors that fulfill three roles: 1. A sensor or collection of sensors that can detect objects behind the AMR 100 (something to use for obstruction detection and coarse load detection), 2. a load localization sensor (something to say where the load we want to engage with is), and 3. a load engagement sensor (something to tell the AMR that it has engaged with the load). In some embodiments, the AMR can use fork-tip embedded planar LiDAR sensors 155, a paddle sensor 158, and an IFM PDS pallet localization sensor 159 for load engagement detection.

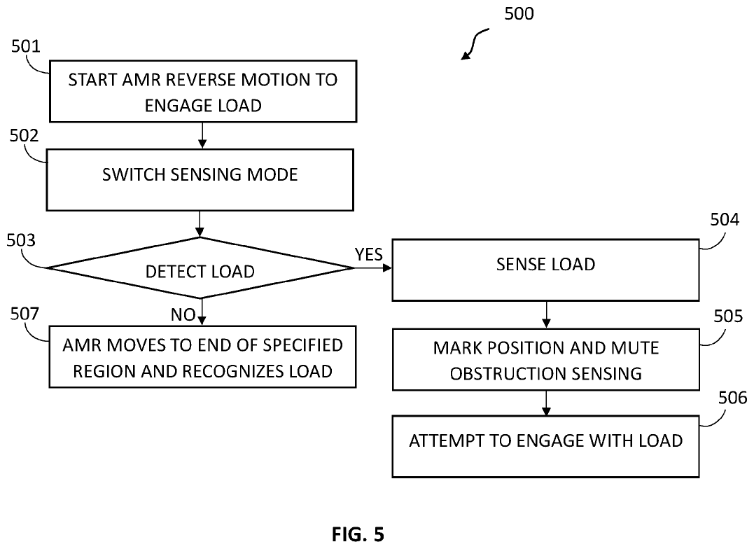

FIG. 5 is a method 500 for engaging with a load, in accordance with aspects of the inventive concepts. The method 500 enables AMR users to define regions within which an AMR 100 can pick a load 106 without needing to specify discrete load locations, and in particular, operations inside the regions. The method 500 permits the AMR 100 to engage with a load in any arbitrary long straight-line region.

At step 501, the AMR 100 starts its reverse motion approach to the region (lane) where it will engage with the load 106. During the reverse motion approaching the region the AMR 100 uses its reverse sensors, e.g., a carriage sensor 156 but not limited thereto, for obstruction detection. Here, the system does not use the load localization sensor 159 or check the load engagement sensor 158.

At step 502, once the AMR is in line with the load engagement region (lane) it switches its sensing mode to leverage its sensors differently. The AMR uses its reverse fork-tip sensors for obstruction detection, starts using its load detection sensor, e.g., a paddle sensor 158 located on the chassis (different location than shown in FIGS. 1A-1C and therefore not shown in FIGS. 1A-1C), in a low fidelity high speed mode, and does not check the load engagement sensor 158.

At decision diamond 503, a determination is made whether there is a load behind the AMR 100 that it could engage with. If yes, the method 500 proceeds to step 504 where AMR's load detection sensor can sense the load 106, and at step 505 mark the position and mute the obstruction sensing from the reverse obstruction sensors. Once the obstruction sensing is muted, at step 506, the AMR 100 can attempt to engage with the load 106. The AMR's obstruction sensors could stop the AMR 100 and trigger switching the load detection sensor into a slower high-fidelity mode. If the load detection sensor finds the load 106, the AMR 100 will attempt to engage with it. At this point, the AMR 100 knows how far back the load 106 is relative to its current position and it can use this information to ensure that it does not travel past the position of the load. The AMR 100 will continue backwards until its load engagement sensor is triggered, stopping the AMR 100 and indicating it can move forward, or the AMR 100 reaches the point where the AMR knows the load to be and any further may result in pushing the load 106. In the second case we stop operations for safety reasons.

If at decision diamond 503, a determination is made whether there is no load behind the AMR 100, the AMR 100 may move until it reaches the end of the specified region (lane) without ever detecting a load 106 and is able to recognize that the load 106 was picked and respond appropriately.

FIG. 6A is a diagram of an embodiment of an AMR 100 performing a load pickup operation using a combination of sensors, in accordance with aspects of the inventive concepts. In some embodiments, the sensors include one or more fork-tip embedded planar LiDAR sensors 155, a pallet localization sensor 159, and load engagement sensors 158. In this figure, the AMR 100 includes fork tip scanners 155 that are scanning as the AMR approaches the load. Before the AMR gets close to the load, low-fidelity, fast PDS can be performed to locate the load/pallet. When the fork tips get closer to the load 106, the sensing can automatically switch to a higher fidelity scanning wherein the AMR 100 moves more slowly. This allows the AMR 100 to determine engagement portions of the load and align itself properly to engage the load. FIG. 6B is a diagram of an embodiment of the AMR 100 having picked up the load 106 of FIG. 3A, in accordance with aspects of the inventive concepts. Details the pick operation illustrated of FIG. 6B are described with respect to the engagement methods in accordance with embodiments described herein and are not repeated for brevity.

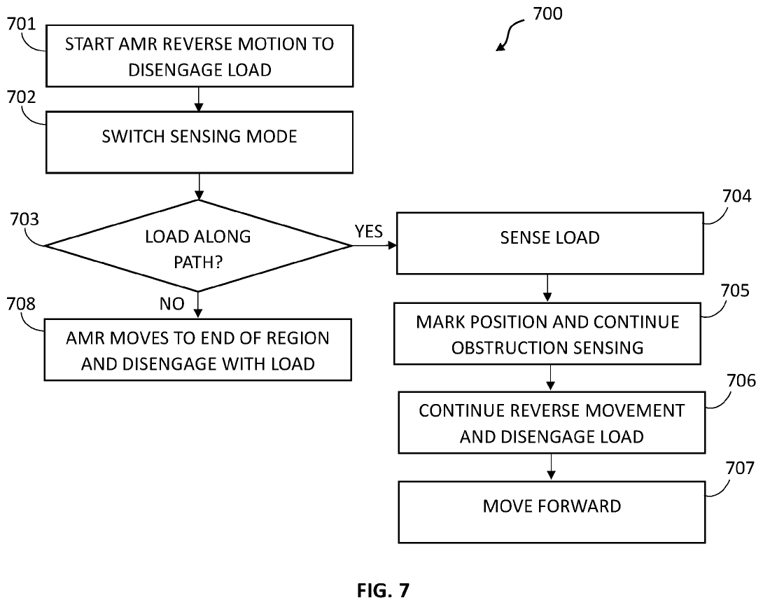

FIG. 7 is a method 700 for dropping a load by an AMR 100, in accordance with aspects of the inventive concepts. Method 700 is similar to method 500 described above, except that method 700 requires fewer sensors. Here, the AMR requires sensors to fulfill two roles: The first role relates to reverse obstruction detection and ranging that is not occluded while carrying a load. The second role includes an engagement sensor used to determine or confirm that the AMR has disengaged from a load. In some embodiments, the AMR includes fork-tip embedded planar LiDAR sensors 155 and a paddle sensor 158 for load engagement/disengagement. Equipped with those sensors the AMR can do the following sequence for disengaging with its load in a region.

The method begins at step 701 when the AMR starts its reverse motion approach to the region (lane) where it will disengage with its load. During the reverse motion approaching the region, the AMR uses its reverse sensors for obstruction detection and checks its engagement sensor to make sure it is still carrying its load.

At step 702, once the AMR is in line with the load disengagement region (lane), it switches its sensing mode to leverage its sensors differently. In addition to using the information coming from the reverse sensors for obstruction detection, the AMR also uses the data for Object of Interest (OOI) detection. An OOI is intended to be a load or object that the AMR is carrying and that should be placed within the disengagement region (lane).

At decision diamond 703, a determination is made whether there is a load behind the AMR 100 along its path that it could engage with

At step 704, if there is a load or object of interest in the lane, the AMR will detect it using its OOI detection algorithm and at step 705 note the position of it.

At step 706, once an OOI is detected, the AMR can continue using the reverse sensors for obstruction detection to find any transitory obstructions that may travel through the scene. The AMR can continue reversing backwards until it reaches a configured distance offset from the location of the OOI detection. At this point, at step 707, the AMR can disengage with its load and move forward.

At step 708, if the region is empty and OOI detection never finds an object in the region, the AMR can travel to the end of the region and disengage with its load.

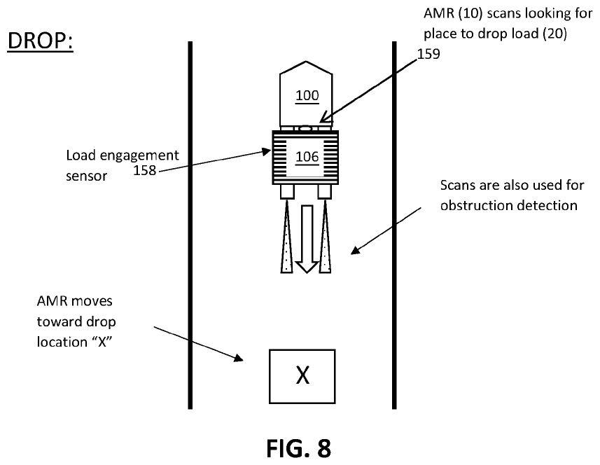

FIG. 8 is a diagram of an embodiment of an AMR 100 performing load 106 drop off, in accordance with aspects of the inventive concepts. Here, the AMR 10 scans for a drop location “X” as it navigates to the drop location. In various embodiments, this scanning can involve use to the fork tip scanners 155, which can be used for obstruction detection.

Using the approaches outlined in accordance with the inventive concepts, AMRs are able to respond more robustly to the manual placement of loads as well as simplify training needs so that regions can be specified rather than specific interaction locations. This reduces the installation cost of AMRs and increases the success rate of picks and drops during operations. Additionally, the approach is not limited to regions of a specific size. The method of sensing and sensor context switching can be used to interact with loads in regions of any arbitrary length.

The methods for engaging and dropping loads in accordance with the inventive concepts, for example, described herein, do not need to be limited to AMR pallets. In other embodiments, a load localization sensor can be used instead of a pallet localization sensor and the method for engaging with a load can be applied for a different type of load. In various embodiments, the method could be used for a lane depletion with a tugger and a lane of staged carts pulled by a tugger.

The methods for engaging and dropping loads in accordance with the inventive concepts, for example, described herein, may be performed by a load interaction system configured to exchange information with the plurality of sensors, e.g., sensors 155, 158 and/or 159, and configured to operate in a load engagement mode and a load drop mode by selectively fusing data from among the plurality of sensors in each mode. For example, a plurality of sensors, e.g., a planar scanner, 3d lidar, and a stereo camera, may sense a region behind the robotic vehicle for dropping a load. The system can store program code of a confidence model for each of these sensors based on known characteristics and limitations of the sensors and fuse the output of the three of them by scaling against our confidence models to build a probability map of the space behind the robotic vehicle 100, leading to more robust OOI detection with fewer false positives.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. An autonomous mobile robot (AMR), comprising:
a chassis, a navigation system, and a load engagement portion;
a plurality of sensors, including an object detection sensor, a load identification sensor, and a load presence sensor;
a load interaction system configured to exchange information with the plurality of sensors and configured to operate in a load engagement mode and a load drop mode, wherein in the load engagement mode, the object detection sensor determines a localization range of a load, the load identification sensor determines a location of the load relative to the AMR, and the load presence sensor signals that the AMR has successfully engaged with the load.

2. The mobile robot of claim 1, wherein the object detection sensor includes at least one planar scanner or other type of depth sensor.

3. The mobile robot of claim 2, wherein the at least one planar scanner is at least one LiDAR scanner.

4. The mobile robot of claim 3, wherein the at least one LiDAR scanner includes at least one fork tip scanner.

5. The mobile robot of claim 1, wherein the load presence sensor includes a pallet detection scanner, sensor, or system.

6. The mobile robot of claim 5, wherein the pallet detection scanner, sensor, or system includes a 3D sensor and/or a 3D camera.

7. The mobile robot of claim 1, wherein the load presence sensor includes at least one paddle sensor.

8. The mobile robot of claim 7, wherein the at least one engagement or at least one paddle sensor is arranged to trip when the load is fully engaged by the AMR.

9. The mobile robot of claim 1, wherein in the load engagement mode the load interaction system is configured to locate the load using a low-fidelity mode.

10. The mobile robot of claim 9, or wherein in the load engagement mode the load interaction system is configured to switch to a high-fidelity mode to engage the load when the object detection sensor determines the localization range.

11. The mobile robot of claim 1, wherein in the load drop mode the load interaction system is configured to use the object detection sensor to perform object detection when approaching a load drop off zone.

12. The mobile robot of claim 1, wherein in the load engagement mode the load interaction system is configured to locate the load using a low fidelity mode.

13. The mobile robot of claim 1, wherein the load interaction system is configured to locate an object of interest (OOI) as a reference for dropping the load.

14. The mobile robot of claim 1, wherein the load interaction system is configured to determine a load drop zone offset from the object of interest (OOI).

15. A load interaction method of an autonomous mobile robot (AMR), comprising:
providing the AMR including:
a chassis, a navigation system, and a load engagement portion;
a plurality of sensors, including an object detection sensor, a load identification sensor, and a load presence sensor;
a load interaction system; and
the load interaction system exchanging information with the plurality of sensors and operating in either of a load engagement mode or a load drop mode, wherein in the load engagement mode, the object detection sensor determines a localization range of a load, the load identification sensor determines a location of the load relative to the AMR, and the load presence sensor signals that the AMR has successfully engaged with the load.

16.-22. (canceled)

23. The method of claim 15, further comprising the load interaction system locating the load using a low-fidelity mode.

24. The method of claim 16, further comprising switching in the load engagement mode to a high-fidelity mode to engage the load.

25. The method of claim 15, further comprising using at least one of the plurality sensors to perform object detection when approaching a load drop off zone.

26. (canceled)

27. The method of claim 15, further comprising locating an object of interest (OOI) as a reference for dropping the load.

28. The method of claim 19, further comprising determining a load drop zone offset from the object of interest (OOI).

29. The mobile robot of claim 1, wherein the plurality of sensors are further configured to selectively fuse data from among the plurality of sensors in each of the load engagement mode and a load drop mode.

30. The mobile robot of claim 29, further comprising a processor that generates a confidence model for each of the plurality of sensors based on known characteristics and limitations of the sensors and fuses an output of the sensors by scaling against the confidence model to build a probability map of a region about the AMR.

31. The method of claim 15, wherein the plurality of sensors are further configured to selectively fuse data from among the plurality of sensors in each of the load engagement mode and a load drop mode.

32. The mobile robot of claim 31, further comprising a processor that generates a confidence model for each of the plurality of sensors based on known characteristics and limitations of the sensors and fuses an output of the sensors by scaling against the confidence model to build a probability map of a region about the AMR.

33. The mobile robot of claim 1, wherein in the load drop mode, the object detection sensor performs a scanning operation to identify an object of interest to place the load next to, and after the object of interest is identified, the object detection sensor performs an obstruction detection operation.

34. The method of claim 15, wherein in the load drop mode, the object detection sensor performs a scanning operation to identify an object of interest to place the load next to, and after the object of interest is identified, the object detection sensor performs an obstruction detection operation.

35. The mobile robot of claim 1, wherein the object detection sensor and the load presence sensor paddle sensor are co-located on first and second forks of the AMR.
